(19) United States
(12) Patent Application Publication
(10) Pub. No.: US 2025/0092931 A1
(43) Pub. Date: Mar. 20, 2025

(54) PRELOAD ADJUSTER

(71) Applicant: Marcus MCBAIN, Rolla, MO (US)

(72) Inventor: Marcus MCBAIN, Rolla, MO (US)

(21) Appl. No.: 18/370,123

(22) Filed: Sep. 19, 2023

(51) Int. Cl. F16F 1/04; B62K 25/08

(52) U.S. Cl. CPC F16F 1/041; B62K 25/08; F16F 2228/08; F16F 2230/0052; F16F 2230/186; F16F 2230/30; F16F 2232/08; F16F 2234/02

(57) ABSTRACT

A preload adjuster includes a main housing, a slide, and an adjuster stem. The slide is configured to telescopically translate relative to the main housing without rotating relative to the main housing. The slide includes a threaded slide portion. The adjuster stem is configured to rotate within the main housing. The adjuster stem has a threaded stem portion configured to mate with the threaded slide portion. Rotation of the adjuster stem modulates a length of the preload adjuster by telescopically translating the slide relative to the main housing.

### FIELD OF THE INVENTION

The present invention relates to a preload adjusting device.

### BACKGROUND OF THE INVENTION

In certain applications, it is useful to preload a biasing device such as a spring or pneumatic cylinder. That is, the biasing device is partially compressed. For example, motor vehicle suspension components are often preloaded to pre-compress the travel in the suspension that would have been caused by the weight of the vehicle and/or operator and to reduce excessive movement in the suspension. Preload can also be useful in establishing a geometry for the suspension.

Traditionally, the front forks of a motorcycle include a preloaded spring in each telescopic tube. The preload is applied to the spring using a spacer having a set length, such as 50 millimeters, for example. For some motorcycles, the amount of force on the preloading spacer can be 50 kilograms or more. This amount of force can make changing the preloading plug difficult and trial and error replacement of the preloading spacer to fine tune the preload can be time consuming.

In an attempt to address the lack of adjustability, conventional adjustable preload devices can be used to make small adjustments in the preload. In this regard, conventional adjustable preload devices include a movable component that is confined within a cage-like structure or otherwise confined within a housing. Unfortunately, this movable component of conventional adjustable preload devices has a range of motion that is only 1-2 centimeters. As a result, the adjustability of conventional adjustable preload is insufficient to accommodate larger changes in preload due to rider weight, ride style, and the like.

Accordingly, it is desirable to provide a preload adjuster that can offer improved adjustment, performance and/or efficiency without the undesirable task of replacing the preloading spacer.

### SUMMARY OF THE INVENTION

The foregoing needs are met, at least in part, by the present invention where, in one embodiment a preload adjuster is disclosed.

An embodiment of the present invention provides a preload adjuster including a main housing, a slide, and an adjuster stem. The slide is configured to telescopically translate relative to the main housing without rotating relative to the main housing. The slide includes a threaded slide portion. The adjuster stem is configured to rotate within the main housing. The adjuster stem has a threaded stem portion configured to mate with the threaded slide portion. Rotation of the adjuster stem modulates a length of the preload adjuster by telescopically translating the slide relative to the main housing.

Another embodiment relates to a system that includes a fork tube and a preload adjuster. The fork tube includes an outer tube and inner tube that telescopically slide relative to one another and a spring to bias the fork tube in an extended conformation. The preload adjuster is disposed at one end of the fork tube and configured to apply a preload to the spring. The preload adjuster includes a main housing, a slide, and an adjuster stem. The slide is configured to telescopically translate relative to the main housing without rotating relative to the main housing. The slide includes a threaded slide portion. The adjuster stem is configured to rotate within the main housing. The adjuster stem has a threaded stem portion configured to mate with the threaded slide portion. Rotation of the adjuster stem modulates a length of the preload adjuster by telescopically translating the slide relative to the main housing.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an orthogonal view of a motorcycle having front forks with preload adjusters according to an embodiment of the present invention.

FIG. 2 is a cut away view of a top portion of a fork tube in the front forks depicted in FIG. 1.

FIG. 3 is a cross-sectional view of the preload adjuster for the fork tube of FIG. 1.

FIG. 4 is an orthogonal view of an upper portion of the preload adjuster of FIG. 1.

FIG. 5 is a side view of the preload adjuster in a collapsed conformation.

FIG. 6 is a side view of the preload adjuster in an extended conformation.

FIG. 7 is a top view of the components to assemble a pair of the preload adjusters of FIG. 1.

### DETAILED DESCRIPTION

In general, embodiments of a preload adjuster described herein are suitable for use with any system that includes a spring or other biasing device and where it would be useful to apply a preload to the system. For example, as described herein, advantages of the preload adjuster include: providing an adjustable amount of preload; facilitating maintenance and improving safety by allowing preload to be reduced prior to disassembly; improving aesthetic by allowing end caps to be secured to the tops of the fork tubes; facilitating retention of lubrication within the fork tubes; providing a seal against the ingress of debris and fluids; and being capable of installation on OEM equipment and also as retrofit to units in the field. These and other advantages are described herein.

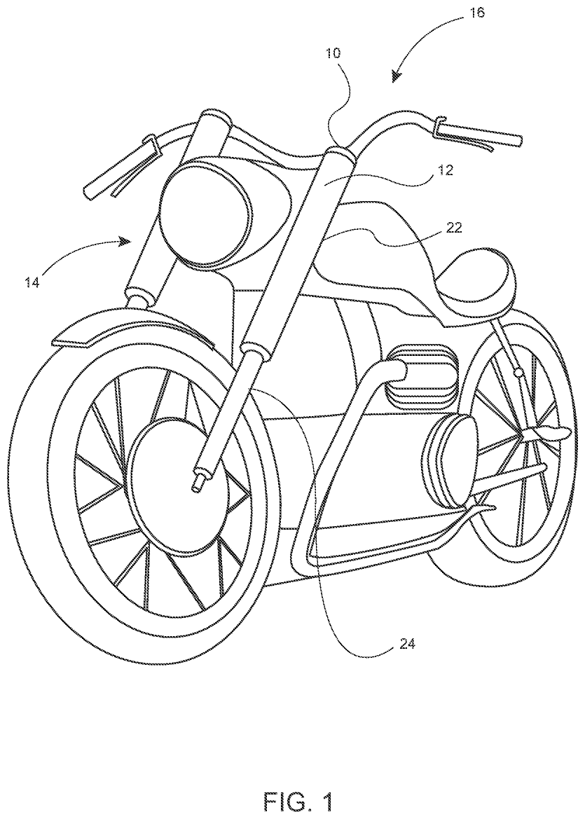

With reference to FIG. 1 a preload adjuster 10 is shown disposed on each of a pair of fork tubes 12 that make up the front forks 14 of a motorcycle 16. In general, the preload adjuster 10 is suitable for use with a variety of sprung, pneumatic, and any other such devices that would benefit from the application of preload. As such, while FIG. 1 shows the preload adjuster 10 disposed in the front forks 14 of the motorcycle 16, in other examples, the preload adjuster 10 may be disposed in the suspension components of other vehicles, other struts, lift supports, and the like. More particularly, the preload adjuster 10 is suitable for use in systems in which it is beneficial to adjust the preload and/or reduce the preload prior to disassembly and then re-apply preload during re-assembly.

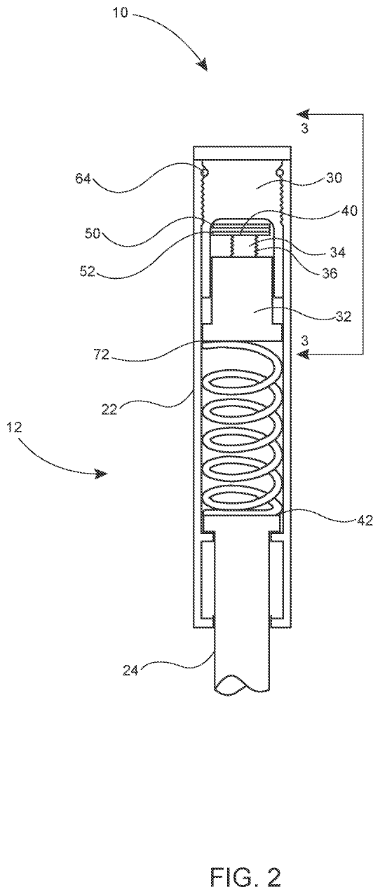

FIG. 2 is a cut away view of a top portion of the fork tube 12 of the front forks 14 depicted in FIG. 1. As shown in FIG. 2, the fork tube 12 includes a spring 20 disposed in an outer tube 22 that provides a biasing force to urge an inner tube 24 to telescopically extend out from the outer tube 22. The preload adjuster 10 is disposed in the fork tube 12 to compress the spring 20. In various examples, the preload adjuster 10 may compress the spring 20 by a predetermined or empirically derived amount. For example, a manufacturer may determine an amount of preload based on a spring rate of the spring 20, a weight of the motorcycle 16, and/or an average or actual weight of a rider. Other variables that may be factored into the predetermined preload include ride quality, motorcycle type, expected use (e.g., cruising, racing, off road, etc.), and the like. The spring rate is a measurement of the amount of force needed to compress a spring a particular distance and the spring rate has a value measured in either pounds per inch (in the royal system) or newtons per millimeter (in the metric system). Without being confined to any particular scientific principle, the spring rate may be approximately linear across a range of compression or may be progressive so that the spring rate increases as compression increases across a range of compression. However, for any particular conventional spring, the spring rate has a predetermined value across its range of compression and remains substantially the same. Regardless of what type of spring is utilized in the fork tube 12, preload is applied to offset at least a portion of the weight of the motorcycle 16 and the rider.

While the preload adjuster 10 shown in FIG. 2 is disposed within a fork tube 12 in which the outer tube 22 is disposed relatively above the inner tube 24, in other examples, the outer tube 22 may be disposed relatively below the inner tube 24. That is, the fork tube 12 may be inverted relative to the orientation shown in FIGS. 1 and 2. In addition, it is envisioned that the preload adjuster 10 may be disposed in a suspension system that is horizontally oriented. Furthermore, while a pair of fork tubes 12 are shown in FIG. 1, in other examples, the preload adjuster 10 is suitable for use in a system with just one or three or more suspension components similar to the fork tube 12.

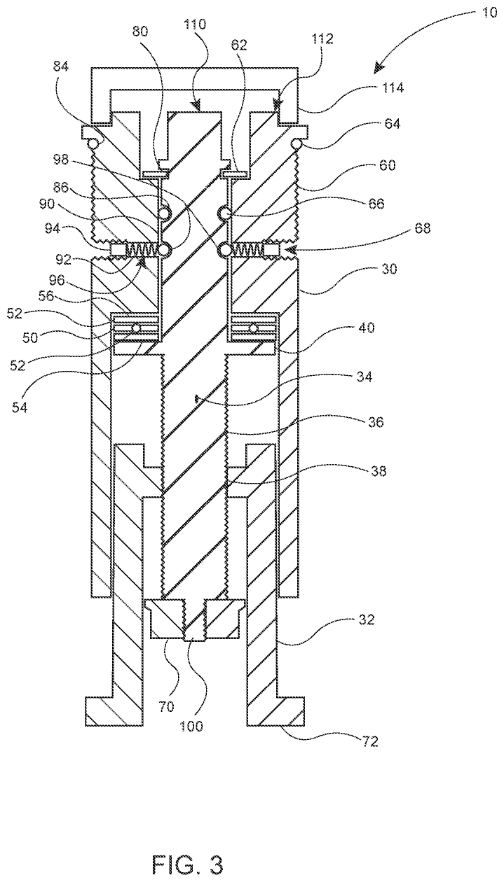

As shown in FIG. 2, this preload is applied to the spring 20 via the preload adjuster 10 being urged into the outer tube 22 to bear upon the spring 20 and the preload adjuster 10 is secured in the outer tube 22 via threads or other such fastening. As further described herein, the amount of preload may be modulated via the preload adjuster 10 by expanding (e.g., lengthening) or collapsing (e.g., shortening) the preload adjuster 10. In this regard, the preload adjuster 10 includes a main housing 30, a slide 32, and an adjuster stem 34. As shown in more detail in FIG. 3, the adjuster stem 34 includes a threaded stem portion 36 that is configured to mate with a threaded slide portion 38. As shown in FIG. 3, the adjuster stem 34 includes a flange 40 configured to prevent the adjuster stem 34 from extending further into the main housing 30 while allowing the adjuster stem 34 to rotate relative to the main housing 30. In response to rotating the adjuster stem 34, the engagement of the threaded stem portion 36 and the threaded slide portion 38 cause the slide 32 to translate along the adjuster stem 24. In this manner, the amount of preload is adjusted. It is an additional benefit that the adjustment of the preload does not result in any portion of the preload adjuster 10 extending out from the fork tube 12. For example, if a protective or decorative cap 114 is optionally used to cover the end of the fork tube 12, anything protruding from the fork tube 12 may interfere with securing the cap 114 to the fork tube 12. In contrast to conventional adjustable preload devices, the adjuster stem 34 and no other portion of the preload adjuster 10 protrudes further up from the fork tube 12 in response to adjustment of the preload.

Of note, for the sake of brevity, the fork tube 12 shown in FIG. 2 is a simplified fork tube. For example, the spring 20 is shown occupying the outer tube 22 and bearing upon a top rim 42 of the inner tube 24, in other examples, the spring 20 may extend into the inner tube 24. In addition, or alternatively, the fork tube 12 may include a dampening device such as a fluid filled damper, for example. Moreover, the preload adjuster 10 is suitable for use in fork tubes with these and other well understood modification and additions.

FIG. 3 is a cross-sectional view of the preload adjuster 10 for the fork tube 12 of FIG. 1. As shown in FIG. 3, the preload adjuster 10 includes the main housing 30, the slide 32, and the adjuster stem 34. As described herein, the threaded stem portion 36 mates with the threaded slide portion 38 to translate the slide 32 along the adjuster stem 34 in response to the adjuster stem 34 being rotated. The adjuster stem 34 includes the flange 40 to prevent the adjuster stem 34 from further extending into the main housing 30 while allowing the adjuster stem 34 to rotate relative to the main housing 34. To further facilitate rotation of the adjuster stem 34, a bearing 50 and pair of thrust washers 52 may be disposed between a bearing face 54 of the flange 40 and a bearing face 56 of the main housing 30.

Also shown in FIG. 3, the preload adjuster 10 includes a main housing threaded portion 60, a circlip 62, an external O-ring 64, an internal O-ring 66, one or more spring-loaded ball detents 68, a retention nut 70, and a slide bearing-surface 72. The main housing threaded portion 60 is configured to secure the preload adjuster 10 in the fork tube 12 as shown in FIG. 2. More particularly, the main housing threaded portion 60 is configured to secure an upper portion of the main housing 30 in an upper portion of the fork tube 12 as shown in FIG. 2. With the main housing 30 secured in the fork tube 12, the modulation in the length of the preload adjuster 10 results in an adjustment of the preload on the spring 20 shown in FIG. 2. Of note, while the examples shown in FIG. 3 include the main housing threaded portion 60, in various other examples, the main housing 30 and the fork tube 12 may include pins, bolts, a bayonet-type fitting, a press fitting, or other known structures to secure the main housing 30 in the fork tube 12.

The circlip 62 or other such retaining device is disposed in an annular groove 80 and configured to secure the adjuster stem 34 in the main housing 30. In use, the circlip 62 may be subjected to little or no force. Instead, the circlip 62 is configured to retain the adjuster stem 34 in the main housing 30 when the preload adjuster 10 is not applying a preload such as, for example, during assembly and disassembly of the fork tube 12.

The external O-ring 64 and internal O-ring 66 are disposed in respective seats 84 and 86. In some examples, the O-rings 64 and 66 may be optional such as, for example, if the environment the preload adjuster 10 is used in is debris-free, the system the preload adjuster is used in is not adversely affected by the ingress of debris such as dirt and/or liquids. However, for use in the motorcycle 16, typically, the O-rings 64 and 66 will be included and configured to reduce or prevent the ingress of water and/or debris such as dirt, sand, and road salt. In addition, the O-rings 64 and 66 may be configured to reduce or prevent the loss of lubrication from the preload adjuster 10 and/or the fork tube 12.

The one or more spring-loaded ball detents 68 each include a ball 90, spring 92, and capscrew 94 disposed in a bore 96 through the main housing 30. The adjuster stem 34 includes a respective detent 98 disposed in cooperative alignment with the ball 90 disposed in the bore 96. The one or more spring-loaded ball detents 68 are configured to facilitate tracking the amount of preload adjustment. For example, the spring-loaded ball detents 68 make a ‘click’ noise and provide haptic feedback to the user as the user rotates the adjuster stem 34. This auditory and haptic feedback allow the user to keep track of the amount of preload applied to the preload adjuster 10 of one fork tube 12 so that the user can more easily apply the same amount of preload adjustment to the other fork tube 12 of the front forks 14.

In addition, the one or more spring-loaded ball detents 68 are configured to reduce or prevent unintended rotation of the adjuster stem 34 in the main housing 30. For example, the combination of the preload force on the preload adjuster, the pitch of the threaded stem portion 36, and vibration of the preload adjuster 10 may generate an unintended rotational force that urges the adjuster stem 34 to rotate relative to the main housing 30. The number of spring-loaded ball detents 68 and the characteristics of the various components of the spring-loaded ball detents 68 may be selected to counteract the unintended rotational force and reduce or prevent the unintended rotation of the adjuster stem 34 in the main housing 30. In the particular example shown in FIG. 3, the preload adjuster 10 includes two spring-loaded ball detents 68. However, in other examples, one, three, four, or more of the spring-loaded ball detents 68 may be disposed in the preload adjuster 10.

The retention nut 70 is secured to an end of the adjuster stem 34 and configured to prevent the threaded stem portion 36 from being unscrewed out from the threaded slide portion 38. While the retention nut 70 is shown as a threaded nut that is secured to a threaded stub 100 of the adjuster stem 34, in other examples, a circlip or other device may be used to prevent the threaded stem portion 36 from being unscrewed out from the threaded slide portion 38.

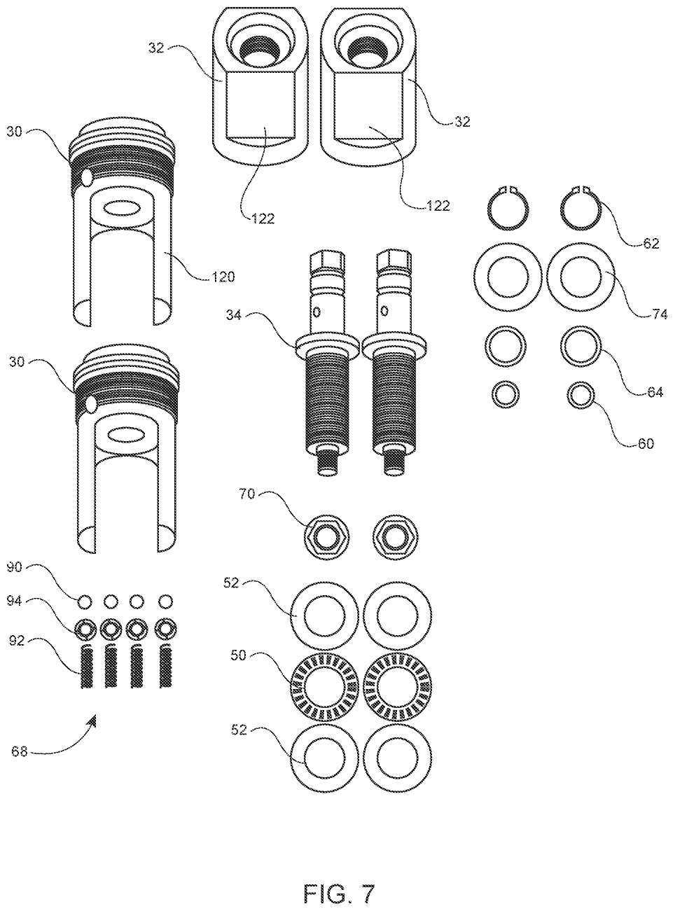

With reference to FIGS. 2 and 3, the slide bearing-surface 72 is configured to bear upon the spring 20. By adjusting the distance that the slide bearing-surface 72 extends into the fork tube 12, the preload on the spring 20 is adjusted. Optionally, a thrust washer 74 (shown in FIG. 7) may be disposed between the circlip 62 and the main housing 30.

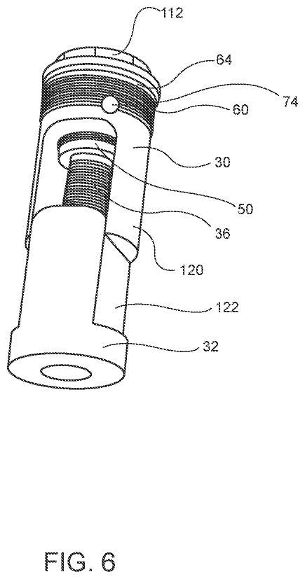

Of note, with reference to FIGS. 2 and 3, the slide 32 is unencumbered by the confines of any structure in the main housing 30. That is, in comparison to conventional preload adjusters, the slide 32 and slide bearing-surface 72 are not confined within a cage-like structure or internal flange of a main housing that prevents the slide from freely extending. As a result of this traditional confinement, conventional preload adjusters are only capable of extending less than 2 centimeters. It is an advantage of the present preload adjuster 10 that the slide 32 is unencumbered from the main housing and is able to telescope freely along the main housing 30. As such, in the extended conformation shown in FIG. 6, the preload adjuster 10 may extend more than 5 centimeters in comparison to the preload adjuster 10 in the collapsed conformation shown in FIG. 5. Due to the greater amount of preload adjustment the preload adjuster 10 is capable of performing in comparison to conventional preload adjusters, the user or service mechanic is able to fully adjust the preload of the front forks 14 to accommodate different rider weights, riding style, and the like without the extra work and potential danger of adding or removing spacers that are required in conventional preload adjuster installations. For example, when adding and removing conventional spacers, great care most be exercised to control the fork tube and the spacer while threading or unthreading the spacer to/from the fork tube. Depending on a number of factors, the forces on the spacer may exceed 50 kg. This preload force most be applied to the spacer while it is being threaded onto the fork tube.

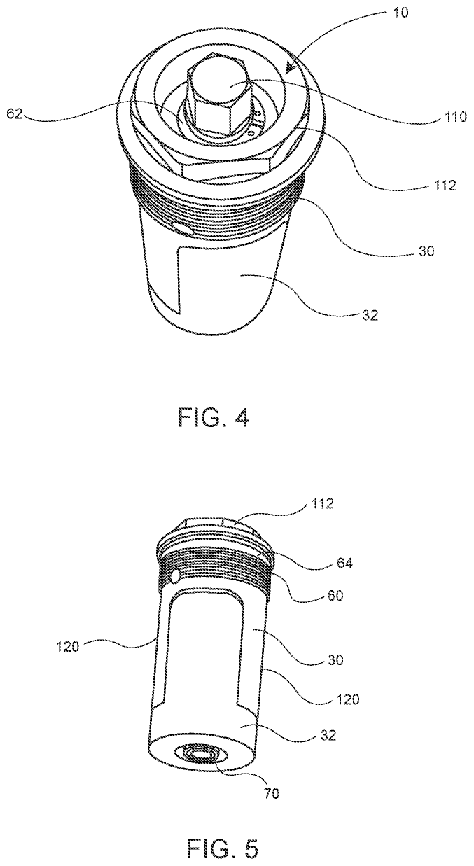

FIG. 4 is an orthogonal view of an upper portion of the preload adjuster 10 of FIG. 1. As shown in FIG. 4, the upper portion of the preload adjuster 10 includes a stem interface 110 and a main housing interface 112. The stem interface 110 is disposed at an upper portion of the adjuster stem 34 and is configured to receive a tool such as a socket and socket wrench (not shown). The stem interface 110 facilitates the application of torque from the adapter to the adjuster stem 34. In the particular example shown in FIG. 4, the stem interface 110 is a hex head configured to receive a hex socket so that torque from a ratchet wrench, torque wrench, breaker bar, power driver, or other source may be applied to the adjuster stem 34. In other examples, the stem interface 110 may include a hex socket to receive an Allen-type wrench, a TORX head to receive a TORX wrench, a slot to receive a flat-head screwdriver, or other known hardware systems and their respective corresponding tools. The main housing interface 112 is disposed on the upper portion of the main housing 30 and configured to receive an adapter (not shown) such as a socket for a socket wrench, torque wrench, etc. In this manner, the preload adjuster 10 may be threaded into the fork tube 12.

FIGS. 5 and 6 are side views of the preload adjuster 10 in a collapsed and extended conformation, respectively. The collapsed conformation of the preload adjuster 10 as shown in FIG. 5 is relatively shorter in length than the extended conformation of the preload adjuster 10 shown in FIG. 6. This difference in length represents a preload adjustment range for the preload adjuster 10. In the particular example shown in FIGS. 5 and 6, the difference in length between the collapsed and extended conformation represents about a 50% increase in length. In a specific example, if the length of the collapsed preload adjuster 10 is 10.16 cm (4 inches), the length of the extended preload adjuster 10 may be 15.24 cm (6 inches). Thus, the range of preload adjustment is 5.08 cm (2 inches) times the spring rate of the spring 20 given that the preload adjuster 10 is bearing upon the spring 20 when in the collapsed conformation. The total amount of preload on the system will depend on how much the spring 20 is compressed during installation of the preload adjuster 10 in the fork tube 12 in combination with any adjustment to the preload via the preload adjuster 10. For example, if the spring 20 is compressed 2.54 cm (1 inch) during installation of the preload adjuster 10 and the preload adjuster 10 is extended 2.54 cm, the total amount of preload would be 5.08 cm (2 inches) times the spring rate of the spring 20.

Also shown in FIGS. 5 and 6, the main housing 30 and the slide 32 translate relative to one another in a telescoping joint. In the particular example shown in FIGS. 5 and 6, the telescoping joint may be described as a “bridle joint.” To form the bridle joint, the main housing 30 includes a pair of extensions 120 configured to slide telescopically along a corresponding pair of cut outs 122. However, in other examples, the telescoping joint may include any suitable joint that facilitates the main housing 30 and the slide 32 telescopically translating relative to one another without rotating relative to one another. For example, the telescoping joint may include a splined joint or otherwise keyed joint to prevent rotation of the slide 32 relative to the main housing 30. The purpose of this relationship is to prevent the main housing 30 and the slide 32 from rotating relative to one another during adjustment of the adjuster stem 34, because rotation of the adjuster stem 34 may not result in the anticipated adjustment in the preload.

FIG. 7 is a top view of the components to assemble a pair of the preload adjusters 10 of FIG. 1. The various components of the preload adjuster 10 are described herein. In the specific application of the preload adjuster 10 being incorporated into the front forks 14 of the motorcycle 16 shown in FIG. 1, a pair of the preload adjusters 10 may be utilized.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A system comprising:
a fork tube comprising an outer tube and inner tube that telescopically slide relative to one another and a spring to bias the fork tube in an extended conformation; and
a preload adjuster disposed at one end of the fork tube and configured to apply a preload to the spring, the preload adjuster comprising:
a main housing;
a slide configured to telescopically translate relative to the main housing without rotating relative to the main housing, the slide including a threaded slide portion; and
an adjuster stem configured to rotate within the main housing, the adjuster stem having a threaded stem portion configured to mate with the threaded slide portion, wherein rotation of the adjuster stem modulates a length of the preload adjuster by telescopically translating the slide relative to the main housing.

2. The system according to claim 1, further comprising a flange disposed on the adjuster stem, the flange being configured to prevent the adjuster stem from extending into the main housing past a predetermined amount.

3. The system according to claim 2, further comprising a bearing disposed between the flange and a bearing face disposed on the main housing.

4. The system according to claim 3, further including a pair of thrust washers, wherein the bearing is disposed between the pair of thrust washers and wherein the thrust washers are configured to prevent galling on the flange and bearing face.

5. The system according to claim 1, further including an external O-ring disposed in an external seat disposed about the main housing, wherein the external O-ring is configured to form a seal between the main housing and the fork tube.

6. The system according to claim 1, further comprising an internal O-ring disposed in an internal seat disposed about the adjuster stem, wherein the internal O-ring is configured to form a seal between the main housing and the adjuster stem.

7. The system according to claim 1, further comprising a spring-loaded ball detent disposed in the main housing and in cooperative alignment with a detent disposed in the adjuster stem.

8. The system according to claim 2, further comprising a retainer configured to secure the adjuster stem in the main housing, wherein the main housing is captured on the adjuster stem between the flange and the retainer.

9. The system according to claim 1, wherein the main housing and the slide are telescopically joined via a bridle joint configured to prevent the slide from rotating relative to the main housing.

10. The system according to claim 1, further comprising a retention nut disposed on an end of the adjuster stem adjacent to the threaded stem portion, wherein the slide is captured on the adjuster stem between the retention nut and the main housing.

11. A preload adjuster comprising:
a main housing;
a slide configured to telescopically translate relative to the main housing without rotating relative to the main housing, the slide including a threaded slide portion; and
an adjuster stem configured to rotate within the main housing, the adjuster stem having a threaded stem portion configured to mate with the threaded slide portion, wherein rotation of the adjuster stem modulates a length of the preload adjuster by telescopically translating the slide relative to the main housing.

12. The preload adjuster according to claim 11, further comprising a flange disposed on the adjuster stem, the flange being configured to prevent the adjuster stem from extending into the main housing past a predetermined amount.

13. The preload adjuster according to claim 12, further comprising a bearing disposed between the flange and a bearing face disposed on the main housing.

14. The preload adjuster according to claim 13, further including a pair of thrust washers, wherein the bearing is disposed between the pair of thrust washers and wherein the thrust washers are configured to prevent galling on the flange and bearing face.

15. The preload adjuster according to claim 11, further including an external O-ring disposed in an external seat disposed about the main housing, wherein the external O-ring is configured to form a seal between the main housing and the fork tube.

16. The preload adjuster according to claim 11, further comprising an internal O-ring disposed in an internal seat disposed about the adjuster stem, wherein the internal O-ring is configured to form a seal between the main housing and the adjuster stem.

17. The preload adjuster according to claim 11, further comprising a spring-loaded ball detent disposed in the main housing and in cooperative alignment with a detent disposed in the adjuster stem.

18. The preload adjuster according to claim 12, further comprising a retainer configured to secure the adjuster stem in the main housing, wherein the main housing is captured on the adjuster stem between the flange and the retainer.

19. The preload adjuster according to claim 11, wherein the main housing and the slide are telescopically joined via a bridle joint configured to prevent the slide from rotating relative to the main housing.

20. The preload adjuster according to claim 11, further comprising a retention nut disposed on an end of the adjuster stem adjacent to the threaded stem portion, wherein the slide is captured on the adjuster stem between the retention nut and the main housing.
